(19) United States
(12) Patent Application Publication
(10) Pub. No.: US 2013/0330647 A1
(43) Pub. Date: Dec. 12, 2013

(54) SOLID OXIDE FUEL CELL

(71) Applicant: SAMSUNG SDI CO., LTD., Yongin-si (KR)

(72) Inventors: Seung-Tae Lee, Yongin-si (KR); Jan-Dee Kim, Yongin-si (KR); Jun-Won Suh, Yongin-si (KR)

(73) Assignee: SAMSUNG SDI CO., LTD., Yongin-si (KR)

(21) Appl. No.: 13/828,788

(22) Filed: Mar. 14, 2013

(30) Foreign Application Priority Data
Jun. 7, 2012 (KR) 10-2012-0060948

(51) Int. Cl. H01M 8/24

(52) U.S. Cl. CPC H01M 8/2465
USPC 429/452

(57) ABSTRACT

A solid oxide fuel cell includes a plurality of unit cells; a plurality of first current collecting members, each of the first current collecting members extending between two of the unit cells; and a second current collecting member wound around an outer circumferential surface of each of the unit cells associated with one of the first current collecting members, wherein a length of each of the first current collecting members is longer than a distance between the unit cells from which the respective first current collecting member extends.

### CROSS-REFERENCE TO RELATED APPLICATION

This application claims priority to and the benefit of Korean Patent Application No. 10-2012-0060948, filed on Jun. 7, 2012, in the Korean Intellectual Property Office, the entire content of which is incorporated herein by reference.

### BACKGROUND

1. Field

Embodiments of the present invention relate to solid oxide fuel cells (SOFC).

2. Description of the Related Art

Solid oxide fuel cells (SOFCs) operate at a high temperature of about 600 to 1000° C., and have greater efficiency and less contamination, as compared with other types of fuel cells. Typically, SOFCs do not require fuel reformers, and can perform complex generation.

Since such a SOFC has a relatively low voltage, the SOFC is used as a stack configured by connecting a plurality of unit cells to obtain a higher voltage. In the SOFC, the plurality of unit cells are respectively inserted into a plurality of holes formed in a separator and then coupled to the separator. The plurality of unit cells are electrically connected by a current collecting member.

### SUMMARY

Embodiments provide a structure of a solid oxide fuel cell (SOFC) in which a current collecting member positioned between unit cells is extended more than the distance between the unit cells, so that it is possible to prevent the current collecting member from being disconnected even if the temperature of the SOFC increases during the operation of the SOFC.

According to an aspect of the present invention, there is provided a solid oxide fuel cell which includes a plurality of unit cells; a plurality of first current collecting members, each of the first current collecting members extending between two of the unit cells; and a second current collecting member wound around an outer circumferential surface of each of the unit cells associated with one of the first current collecting members, wherein a length of each of the first current collecting members is longer than a distance between the unit cells from which the respective first current collecting member extends.

In one embodiment, an extended length of the first current collecting member is about equal to a potential distance change between the unit cells from which a respective first current collecting member extends due to operation of the solid oxide fuel cell. Further, the potential distance change x is in a range of the following expression: tan θ₁×y≦x≦2×(tan θ₂×y), wherein θ₁ and θ₂ denote angles at which each of a respective one of the unit cells from which a respective first current collecting member extends is warped during operation, and y denotes a distance from a start point at which the respective unit cell is warped to the first current collecting member on the respective unit cell. In one embodiment, θ₁ and θ₂ are 0 to about 30°.

Further, a potential distance change x may be in a range of the following expression: 0.000372×L×(D/T)≦x≦0.0031×L×(D/T), wherein L denotes a length of a respective one of the unit cells, D denotes an external diameter of the respective unit cell, and T denotes a thickness of the respective unit cell. In one embodiment, the value of the potential distance change x is between about 2 mm and 15 mm.

In embodiments, the first current collecting member comprises silver, a current per unit area of the first current collecting member is between about 1000 and about 3500 A/cm², a load per unit area of the first current collecting member is about 1700 kgf/cm² or less, a ductility of the first current collecting member is between about 8% and about 15%, and the unit cell is cylindrical.

As described above, according to the present invention, a current collecting member positioned between unit cells is extended longer by a predetermined length than the distance between the unit cells, so that it is possible to prevent the current collecting member from being disconnected even though the temperature of the SOFC increases during the operation of the SOFC, thereby ensuring the performance and long-term durability of the SOFC.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view showing a fuel cell stack according to an embodiment of the present invention.

FIG. 2 is a graph showing changes in the straightness of a unit cell before/after the high-temperature heat treatment of the unit cell according to the present invention.

FIG. 3A is a sectional view showing a minimum value of a change in the straightness of the unit cell according to an embodiment of the present invention.

FIG. 3B is a sectional view showing a maximum value of a change in the straightness of the unit cell according to the embodiment of the present invention.

FIG. 4 is a sectional view showing a minimum value of a change in the straightness of the unit cell according to another embodiment of the present invention.

FIG. 5 is a sectional view showing the length of the unit cell of which volume expansion occurs due to re-oxidation.

FIG. 6 is a graph showing the result of a current application experiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to another element or be indirectly connected to another element with one or more intervening elements interposed therebetween. Hereinafter, like reference numerals refer to like elements. In the drawings, the thickness or size of layers are exaggerated for clarity and not necessarily drawn to scale.

FIG. 1 is a perspective view showing a fuel cell stack according to the present invention.

Referring to FIG. 1, a solid oxide fuel cell (SOFC) configured as a fuel cell stack according to the present invention includes a plurality of unit cells 10 formed in a cylindrical shape, first current collecting members 31 extending between the unit cells 10, and a second current collecting member 32 wound around an outer circumferential surface of each unit cell 10 provided with the first current collecting member 31. In one embodiment, the length of the first current collecting member 31 positioned between the unit cells 10 may be longer than the distance between the unit cells 10.

The extended length of the first current collecting member 31 may be the value of a potential change in the straightness of the unit cell 10 due to the operation of the SOFC. In embodiments of the present invention, the value of the change in the straightness means the movement distance (i.e., the amount of movement) of the first current collecting member 31 positioned at the uppermost end of the unit cell 10 as measured before and after the operation of the SOFC.

The unit cell 10 of the SOFC according to the present invention has a tubular structure having a cylindrical sectional shape, and is formed by sequentially stacking an anode 11, an electrolyte 12 and a cathode 13. A connection member 14 protrudes from an outer circumferential surface of the anode 11, and extends generally along a longitudinal axis of the unit cell 10 configured to avoid and the cathode 13 is configured to avoid contact with the connection member 14. The respective unit cells 10 formed as described above may be coupled to a separator 20 through openings formed in the separator 20. The unit cell 10 generates electricity by electrochemically reacting hydrogen supplied through the anode 11 and oxygen supplied through the cathode 13.

In one embodiment, the anode is formed as an internal electrode and the cathode is formed as an external electrode. However, it will be apparent that the anode can be formed as an external electrode and the cathode can be formed as an internal electrode.

The first current collecting member 31 is formed in a ‘⊂’ shape so as to electrically connect adjacent unit cells 10, and a first current collecting member 31 is formed on outer circumferential surfaces of unit cells 10a, 10b. The first current collecting members 31 are connected by fixing members 33. In this case, the fixing members 33 are screw-coupled at both sides thereof with the first current collecting members 31 located therebetween, thereby fixing the first current collecting members 31.

The second current collecting member 32 is wound around the outer circumferential surface of each unit cell 10. The second current collecting member 32 is formed in the shape of a wire coupled to the unit cell 10 by being spirally wound around the unit cell 10. Here, the wiring interval of the wound second current collecting member may influence the current collection and performance of the SOFC.

Although the SOFC according to the present invention is formed into a structure in which three pairs of unit cells 10 each having two cells connected in parallel to each other are connected in series to one another (3S2P), the present invention is not limited thereto.

In the SOFC having the structure as described above, it is highly likely that disconnection will occur when the following situations happen. In an embodiment of the present invention, the first current collecting member 31 may be formed of silver (Ag). Since the silver has a melting point of about 960° C. and excellent ductility, the first current collecting member 31 may be disconnected even due to a slight increase in temperature. The first current collecting member 31 may be disconnected when an overload occurs during the operation of the SOFC, when electrical conduction occurs, when the unit cell 10 is warped, or when the SOFC is damaged by a false unit cell 10, among other reasons.

The risk of disconnection may be applied to not only the silver but also to all kinds of metals. If disconnection occurs, the operation of the SOFC is impossible. In an embodiment of the present invention, in order to prevent such a problem, the first current collecting member 31 extending between the unit cells 10 is longer than the distance between the unit cells 10. That is, the first current collecting member 31 has a length to accommodate the unit cell 10 even if the unit cell is deformed and warped by the operation of the SOFC.

In one embodiment, the load of the first current collecting member 31 per unit area may be in a range of about 1700 kg/cm² or less. This is because the tensile strength of the silver is 170 Mpa, and a material having a load greater than that of silver is not used as the material of the first current collecting member 31.

The ductility of the first current collecting member 31 may be formed in a range of between about 8% to 15%. Even when the SOFC is not operated, a change in the straightness of the unit cell 10 may occur due to heat. Therefore, the first current collecting member 31 may be made of a ductile material. In a case where the ductility of the first current collecting member 31 to less than 8%, the first current collecting member 31 may be disconnected when the straightness of the unit cell 10 is changed by heat. In a case where the ductility of the first current collecting member 31 exceeds 15%, the material of the first current collecting member 31 is not appropriate as a material for performing the function of the first current collecting member 31.

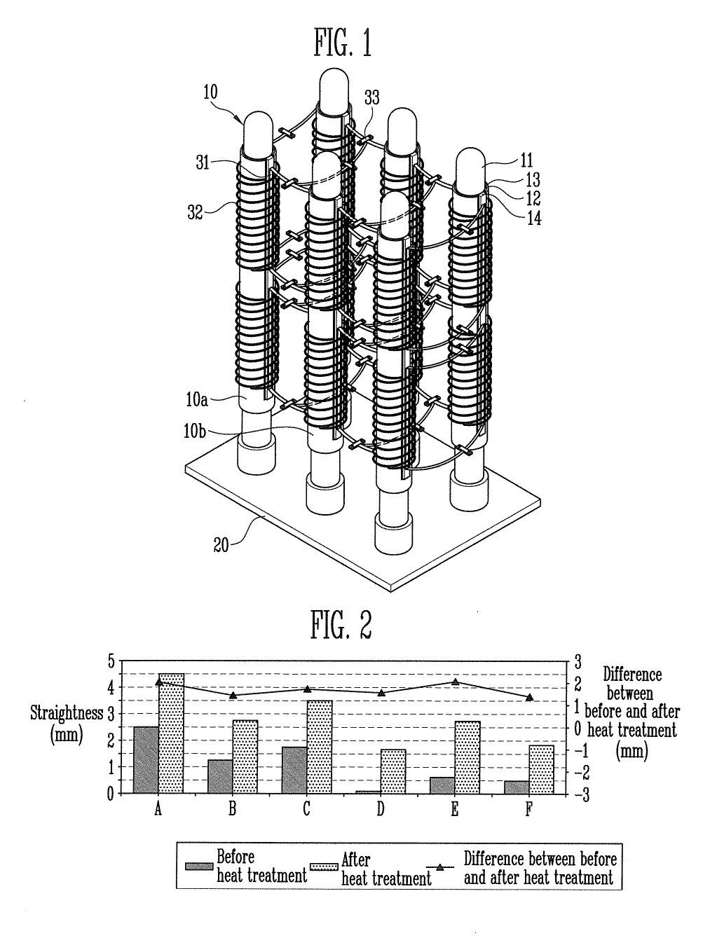

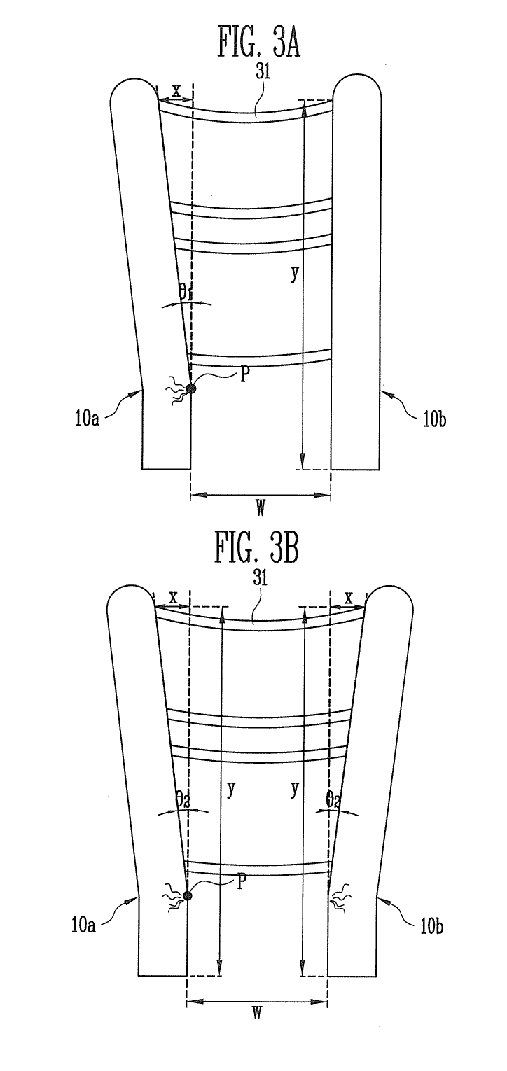

FIG. 2 is a graph showing changes in the straightness of a unit cell before/after the high-temperature heat treatment of the unit cell according to the present invention.

Referring to FIG. 2, values of the change in the straightness of the unit cell before/after the heat treatment may be obtained by performing high-temperature heat treatment on the unit cell 10.

TABLE 1

| | Before heat | After heat | Difference between after and |
|---|---|---|---|
| No. | treatment (mm) | treatment (mm) | before heat treatment (mm) |
| 1 | 2.49 | 4.52 | 1.93 |
| 2 | 1.27 | 2.70 | 1.43 |
| 3 | 1.78 | 3.50 | 1.72 |
| 4 | 0.15 | 1.70 | 1.55 |
| 5 | 0.67 | 2.76 | 2.00 |
| 6 | 0.49 | 1.87 | 1.39 |

As can be seen in Table 1, the unit cell 10 may be slightly warped before the heat treatment. When comparing the result after the heat treatment with the result before the heat treatment, the value of the change in the straightness of the unit cell 10 before/after the heat treatment is between about 1.39 to 2.00 mm. That is, it can be seen that although the operation of the SOFC is not performed, the straightness of the unit cell 10 may be changed by heat, and the straightness of the unit cell 10 may be changed up to a maximum of about 2.00 mm.

Although not shown in Table 1, the value of the change in the straightness of the unit cell having a defect may be a maximum of about 15 mm.

Therefore, the first current collecting member 31 positioned between the unit cells 10 may be extended by between about 2 to 15 mm more than the distance between the unit cells 10. That is, the value of the change in the straightness of the unit cell 10 may be about 2 mm or less due to heat. In a case where the value of the change in the straightness of the unit cell 10 exceeds 15 mm, the unit cell 10 may be broken. In a case where the first current collecting member 31 is longer than 15 mm more than the distance between the unit cells, the length of the first current collecting member 31 is too long, and therefore, much current loss occurs.

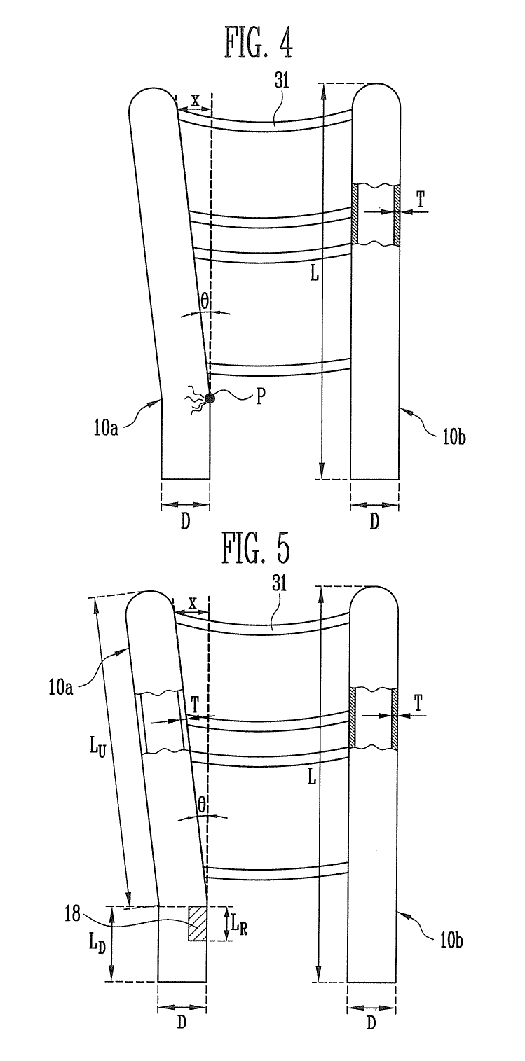

FIG. 3A is a sectional view showing the minimum value of a change in the straightness of the unit cell according to an embodiment of the present invention. FIG. 3B is a sectional view showing the maximum value of a change in the straightness of the unit cell according to the embodiment of the present invention.

Referring to FIGS. 3A and 3B, the value of a change x in the straightness of the unit cell 10 according to this embodiment may be obtained. First, the minimum value of the change in the straightness of the unit cell 10 may be set in a range of the following expression.

x=tan θ₁×y

Here, the θ₁ denotes an angle at which the unit cell is warped, and the y denotes a distance from the start point P at which the unit cell is warped to the first current collecting member positioned at the uppermost end of the unit cell.

As described above, the unit cell 10 may be warped by the heat, but it is assumed that one of the two unit cells 10a and 10b is not warped at all so as to obtain the minimum value of the change x in the straightness of the unit cell 10. Accordingly, the minimum value of the change x in the straightness of the unit cell 10 can be obtained after the operation of the SOFC is performed.

It is assumed that the maximum value of the change x in the straightness of the unit cell after the operation of the SOFC is obtained when the difference in warp between the unit cells 10a and 10b in the opposite directions is greatest. Accordingly, the maximum value of the change x in the straightness of the unit cell 10 may be a value two times greater than that of tan θ₂×y.

x=2×(tan θ₂×y)

The value of the change x in the straightness of the unit cell 10 may be set in the following range.

tan θ₁×y≦x≦2×(tan θ₂×y).

Here, the θ₁ and θ₂ may be set in a range of more than 0 to 30° or less. The unit cell 10 may be slightly warped by the heat. In a case where the warped angle of the unit cell 10 exceeds 30°, the unit cell 10 may be broken.

When assuming that the interval between the unit cells 10 is w, the length of the first current collecting member 31 according to the present invention may be represented as follows.

w+(tan θ₁×y)≦length of first current collecting member≦w+(2×(tan θ₂×y))

As such, the first current collecting member 31 is extended longer than the distance between the unit cells 10, so that disconnection does not occur in the first current collecting member 31, and thus it is possible to easily cope with the change in the straightness of the unit cell 10 as the operation of the SOFC is performed.

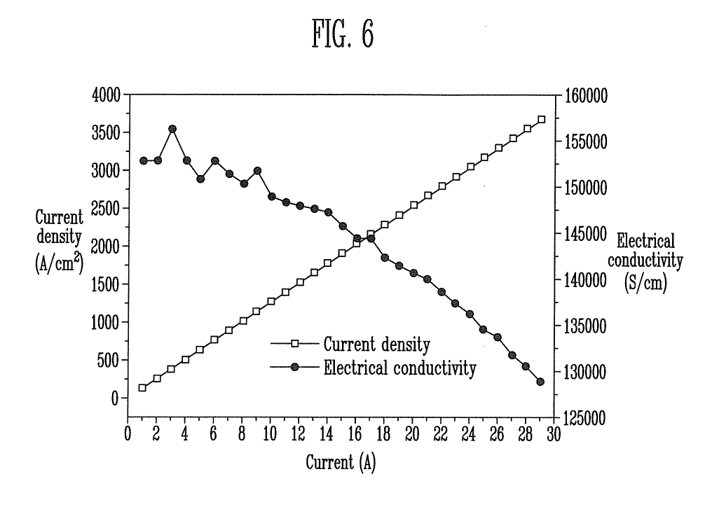

FIG. 4 is a sectional view showing the minimum value of a change in the straightness of the unit cell according to another embodiment of the present invention. FIG. 5 is a sectional view showing the length of the unit cell of which volume expansion occurs due to re-oxidation.

Referring to FIGS. 4 and 5, the unit cell 10 according to this embodiment has a length of about 500 mm, a thickness of about 2 mm and an external diameter of about 21.5 mm. The value of a change in the straightness of the unit cell 10 may be about 2 mm due to the heat. The straightness of the unit cell 10 may be influenced by the length, thickness, and external diameter of the unit cell 10.

The minimum value of the change x in the straightness of the unit cell 10 may be obtained by the following expression.

x=A×L×(D/T)

Here, the L denotes a length of the unit cell, the D denotes an external diameter of the unit cell, and the T denotes a thickness of the unit cell.

The value A may be obtained by substituting 2 mm for the change x in the straightness of the unit cell 10 due to the heat in the expression.

A=2×(2/500×21.5)=0.000372

Therefore, the minimum value of the change x in the straightness of the unit cell may be obtained by the following expression.

x=0.000372×L×(D/T)

If re-oxidation occurs at a lower portion of the unit cell 10 due to a defect of the unit cell 10 during the operation of SOFC, Ni is oxidized to NiO, and therefore, volume expansion occurs at the re-oxidized portion. Since a volume expansion of between about 12% to 14% generally occurs, the unit cell 10 is warped toward a portion at which the re-oxidation does not occur. In a serious case, the unit cell 10 is broken.

In an embodiment of the present invention, the first current collecting member 31 connecting between the unit cells 10 is longer than the distance between the unit cells 10 so as to cope with the warp of the unit cell 10. In this case, the first current collecting member 31 is necessarily formed to have the length calculated by the following expression so as to prevent or reduce the likelihood of the first current collecting member 31 being broken and disconnected by the warp of the unit cell 10.

If a volume expansion of L_{R} occurs due to the re-oxidation, the warp of the unit cell 10 occurs at an upper portion of the unit cell 10. That is, the unit cell 10 is warped by the value of the change x in the straightness of the unit cell 10. If the unit cell 10 is warped due to the re-oxidation and consequently broken, the warp of the unit cell 10 does not occur any more.

As a result in which experiments were performed using the unit cell 10 having a length of 500 mm, the value of a change in the straightness of the unit cells 10 broken by a crack at a lower portion (L_{D}: 50 mm from the bottom of the unit cell) of the unit cells was about 15 mm regardless of the length L_{R} of a re-oxidized portion 18. This means that the unit cell 10 is broken before the value of the change in the straightness of the unit cell is changed to about 15 mm or more. That is, when assuming that a crack occurs at the lowermost end of the unit cell 10, it can be expected that the maximum value of the change in the straight of the unit cell 10 will be about 16.7 mm.

Referring to FIG. 5, the value θ may be obtained using an equation using the length of an arc. In this case, an error between the arc and the straight distance may exist to some degree.

x=2L_{U}π×(θ/360)

Here, the L_{U} denotes a length from the position at which a change in the straightness of the unit cell is started to the uppermost end of the unit cell.

15=2×450×3.14(θ/360)

θ=15/2826×360=1.91°

The length L_{R} generated by the volume expansion may be obtained using the obtained value θ.

Tan 1.91°=L_{R}/T=0.03626

L_{R}=0.0333×21.5=0.71595

Since Ni is oxidized to NiO, and therefore, the volume expansion of 12% to 14% generally occurs, the unit cell 10 is broken even if a re-oxidation of about 5.2 to 6 mm occurs.

That is, like the minimum value, the maximum value of the change x in the straightness of the unit cell 10 due to its re-oxidation may be obtained from the length, thickness and external diameter of the unit cell 10.

x=A×L×(D/T)

A=15×(2/450×21.5)=0.0031

Therefore, the maximum value of the change x in the straightness of the unit cell 10 may be expressed by the following expression.

x=0.0031×L×(D/T)

Accordingly, the length of the first current collecting member 31 may be set in a range of lengths respectively obtained by adding the maximum and minimum values of the change x in the straightness of the unit cell 10 to the distance w between the unit cells 10.

W+(0.000372×L×(D/T))≦x≦w+(0.0031×L×(D/T))

FIG. 6 is a graph showing the result of a current application experiment of the present invention.

Referring to FIG. 6, the first current collecting member 31 according to the present invention was formed of silver having a length of 9 cm and φ1 mm, and experiments of applying current to the first current collecting member 31 were performed. As shown in FIG. 6, a change in electrical conductivity occurred, and the electrical conductivity was changed by resistance generated by the loss of current. Particularly, in a case where a current of 29A is applied to the first current collecting member 31, the disconnection of the first current collecting member 31 occurred.

The current of the first current collecting member 31 per unit area may be within a range of about 1000 to about 3500 A/cm². In a case where the current of the first current collecting member 31 per unit area is less than about 1000 A/cm² through the experiment of applying current to the first current collecting member 31 at 800° C., the loss of current occurs, and therefore, the first current collecting member 31 may be influenced by the loss of current. In a case where the current of the first current collecting member 31 per unit area exceeds about 3500 A/cm², the first current collecting member 31 may be disconnected.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A solid oxide fuel cell comprising:
a plurality of unit cells;
a plurality of first current collecting members, each of the first current collecting members extending between two of the unit cells; and
a second current collecting member wound around an outer circumferential surface of each of the unit cells associated with one of the first current collecting members,
wherein a length of each of the first current collecting members is longer than a distance between the unit cells from which the respective first current collecting member extends.

2. The solid oxide fuel cell according to claim 1, wherein an extended length of the first current collecting member is about equal to a potential distance change between the unit cells from which a respective first current collecting member extends due to operation of the solid oxide fuel cell.

3. The solid oxide fuel cell according to claim 1, wherein the potential distance change x is in a range of the following expression:
tan θ₁×y≦x≦2×(tan θ₂×y),
wherein θ₁ and θ₂ denote angles at which each of a respective one of the unit cells from which a respective first current collecting member extends is warped during operation, and y denotes a distance from a start point at which the respective unit cell is warped to the first current collecting member on the respective unit cell.

4. The solid oxide fuel cell according to claim 3, wherein θ₁ and θ₂ are 0 to about 30°.

5. The solid oxide fuel cell according to claim 2, wherein the potential distance change x is in a range of the following expression:
0.000372×L×(D/T)≦x≦0.0031×L×(D/T),
wherein L denotes a length of a respective one of the unit cells, D denotes an external diameter of the respective unit cell, and T denotes a thickness of the respective unit cell.

6. The solid oxide fuel cell according to claim 5, wherein the value of the potential distance change x is between about 2 mm and 15 mm.

7. The solid oxide fuel cell according to claim 1, wherein the first current collecting member comprises silver.

8. The solid oxide fuel cell according to claim 1, wherein a current per unit area of the first current collecting member is between about 1000 and about 3500 A/cm².

9. The solid oxide fuel cell according to claim 1, wherein a load per unit area of the first current collecting member is about 1700 kgf/cm² or less.

10. The solid oxide fuel cell according to claim 1, wherein a ductility of the first current collecting member is between about 8% and about 15%.

11. The solid oxide fuel cell according to claim 1, wherein the unit cell is cylindrical.
